(19) United States
(12) Patent Application Publication
(10) Pub. No.: US 2012/0221553 A1
(43) Pub. Date: Aug. 30, 2012

(54) METHODS FOR ELECTRONIC DOCUMENT SEARCHING AND GRAPHICALLY REPRESENTING ELECTRONIC DOCUMENT SEARCHES

(75) Inventors: Philip L. Wittmer, Dayton, OH (US); Jon R. Klein, Naperville, OH (US); Peter James Vanderheyden, Naperville, IL (US); Richard Garner, London (GB)

(73) Assignee: LEXISNEXIS, A DIVISION OF REED ELSEVIER INC., Miamisburg, OH (US)

(21) Appl. No.: 13/446,105

(22) Filed: Apr. 13, 2012

Related U.S. Application Data
(63) Continuation of application No. PCT/US2012/026532, filed on Feb. 24, 2012.
(60) Provisional application No. 61/446,431, filed on Feb. 24, 2011.

(51) Int. Cl. G06F 17/30

(52) U.S. Cl. 707/722; 707/775; 707/E17.014

(57) ABSTRACT

Methods for electronic document searching and graphically representing an electronic document search are disclosed. In one embodiment, a method of graphically representing electronic document searches includes generating a Venn diagram for display on a graphic display device including a first circle that represents a first document set and a second circle that represents a second document set. The first circle overlaps the second circle in an overlap region depicting common electronic documents that are within the first document set and the second document set. The method further includes generating a first visualization chart from the first circle and a second visualization chart from the second circle. The first visualization chart and the second visualization chart depict proportions of the first document set and the second document set according to a user-defined parameter. Additional search queries may be suggested based on similar topics within electronic documents within the Venn diagram.

### CROSS-REFERENCE TO RELATED APPLICATIONS

This application is a continuation of U.S. PCT Patent Application No. PCT/US2012/26532, filed Feb. 24, 2012 and which claims the benefit of U.S. Provisional Patent Application Ser. No. 61/446,431, filed Feb. 24, 2011, the entire disclosures of which are hereby incorporated herein by reference.

### BACKGROUND

1. Field

The present specification generally relates to electronic document searching and, more particularly, to systems and methods for graphically representing electronic document searches using visual aids.

2. Technical Background

Document corpuses such as those containing legal documents, patent documents, medical journals, etc. are searched using query expressions. These query expressions may include operators such as Booleans operators (e.g., “and,” “or,” “and not,” etc.) as well as relationship operators (e.g., W/S for words within the same sentence, W/# for words located within a defined number of words). Semantic search queries may also be utilized to search for documents. Semantic search queries expand search terms by finding and using terms that are semantically similar to those in an original search query. In many cases, a user may develop several search queries when researching a particular topic. However, it may be difficult for the user to efficiently determine which search queries provide the most relevant search results and how completely the search queries search the particular topic. Accordingly, many users may not trust their search of the document corpus, and may believe that the generated search results are unreliable, or the generated search results are not fully complete.

Accordingly, a need exists for alternative methods of graphically representing electronic document searches to improve the electronic document searching experience.

### SUMMARY

In one embodiment, a method of graphically representing electronic document searches includes receiving at least a first search query and a second search query, and searching an electronic document database using the first search query and the second search query to obtain a first document set based on the first search query and a second document set based on the second search query. The first document set includes a first plurality of electronic documents and the second document set includes a second plurality of electronic documents. The method further includes generating a Venn diagram for display on a graphic display device including a first circle that represents the first document set and a second circle that represents the second document set. A size of the first circle and the second circle reflect a number of electronic documents in the first document set and in the second document set, respectively. The first circle overlaps the second circle in an overlap region depicting common electronic documents that are within the first document set and the second document set. The method further includes depicting a separation of the first circle from the second circle on the graphic display device in response to a user input, and generating a first visualization chart from the first circle and a second visualization chart from the second circle. The first visualization chart and the second visualization chart depict proportions of the first document set and the second document set according to a user-defined parameter.

In another embodiment, a method of graphically representing electronic document searches includes receiving at least a first search query and a second search query, and searching an electronic document database using the first search query and the second search query to obtain a first document set based on the first search query and a second document set based on the second search query. The first document set includes a first plurality of electronic documents and the second document set includes a second plurality of electronic documents. The method further includes identifying electronic documents in the first document set and the second document set that satisfy at least one user-defined parameter, and generating a Venn diagram for display on a graphic display device including a first circle that represents the first document set and a second circle that represents the second document set. A size of the first circle and the second circle reflect a number of electronic documents in the first document set and in the second document set, respectively, and the first circle overlaps the second circle in an overlap region depicting common electronic documents that are within the first document set and the second document set. The method further includes populating the first circle and the second circle with a plurality of graphical representations of electronic documents satisfying the at least one user-defined parameter, wherein a first portion of the plurality of graphical representations of electronic documents is located within the first circle near a second portion of the plurality of graphical representations of electronic documents located within the second circle.

In yet another embodiment, a method of electronic document searching includes receiving at least a first search query and a second search query, and searching an electronic document database using the first search query and the second search query to obtain a first document set based on the first search query and a second document set based on the second search query. The first document set includes a first plurality of electronic documents and the second document set includes a second plurality of electronic documents. The method further includes generating a Venn diagram for display on a graphic display device including a first circle that represents the first document set and a second circle that represents the second document set. A size of the first circle and the second circle reflect a number of electronic documents in the first document set and in the second document set, respectively. The first circle overlaps the second circle in an overlap region depicting common electronic documents that are within the first document set and the second document set. The method further includes determining one or more semantically similar terms of electronic documents within the overlap region, generating one or more additional search queries based on the one or more semantically similar terms, searching the electronic document database using the one or more additional search queries to obtain one or more additional document sets, and displaying one or more visual representations of one or more search result sets using the one or more additional search queries.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 depicts a schematic illustration of a computing network for a system for graphically representing an electronic search and for enabling an electronic document search, according to one or more embodiments shown and described herein;

FIG. 2 depicts a schematic illustration of the server computing device from FIG. 1, further illustrating hardware and software that may be utilized in performing the electronic document searching and graphical electronic document search representation functionalities, according to one or more embodiments shown and described herein;

FIG. 3 depicts an illustration of a graphical user interface displaying a plurality of search queries available for comparison according to one or more embodiments shown and described herein;

FIGS. 4-7 depict illustrations of a graphical user interface displaying a results presentation region and a Venn diagram having various segments highlighted and selected according to one or more embodiments shown and described herein;

FIG. 8 depicts an illustration of a graphical user interface wherein the Venn diagram is hidden and the results presentation region is in list mode according to one or more embodiments shown and described herein;

FIG. 9 depicts an illustration of a graphical user interface wherein the Venn diagram is hidden and the results presentation region is in table mode according to one or more embodiments shown and described herein;

FIG. 10 depicts an illustration of a graphical user interface displaying a plurality of search queries for selection and further visualization according to one or more embodiments shown and described herein;

FIG. 11 depicts an illustration of a graphical user interface displaying a visualization chart according to one or more embodiments shown and described herein;

FIG. 12 depicts an illustration of a graphical user interface displaying three visualization charts according to one or more embodiments shown and described herein;

FIG. 13 depicts an illustration of a graphical user interface displaying a Venn diagram comprising graphical representations of electronic documents having one or more user-defined parameters according to one or more embodiments shown and described herein;

FIG. 14 depicts an illustration of a graphical user interface displaying a Venn diagram and a plurality of suggested terms according to one or more embodiments shown and described herein;

FIG. 15 depicts an illustration of an alternative graphical representation of search query results comprising a plurality of circles representing search result sets and overlapping regions of the search result sets according to one or more embodiments shown and described herein; and

FIG. 16 depicts an illustration of another alternative graphical representation of search query results comprising a plurality of circles representing search result sets and a plurality of connecting rings representing overlapping regions of the search result sets.

### DETAILED DESCRIPTION

Referring generally to the figures, embodiments described herein are directed to systems and methods for graphically representing two or more electronic document search queries that are used to search an electronic document database, as well as for expanding compared search queries into new search queries. Embodiments of the present disclosure may be utilized as a research tool for a user researching particular issues. Nonlimiting examples include patent document research, legal research, and scientific research. As described in detail below, the embodiments described herein provide for a visual and interactive graphical user interface that enables a user to see how individual search queries compare with one another, as well as to develop new searches based on prior search results. More particularly, some embodiments described herein utilize Venn diagrams to compare the results of two or more search queries. As an example and not a limitation, embodiments may show the user how the results of a Boolean search query compare (e.g., overlap) with the results of a semantic search query. The Venn diagrams may be manipulated by the user to obtain more detail regarding the graphically represented search queries, depict multiple relationships between electronic documents found as a result of the search queries, as well as to develop updated Venn diagrams that reflect the searching needs of the user.

Although the embodiments are described herein in the context of databases storing a document corpus containing patent documents, it should be understood that embodiments are not limited thereto. For example, the methods described herein may be utilized to search document corpuses containing patent documents, legal documents, scientific research documents, news articles, journals, etc.

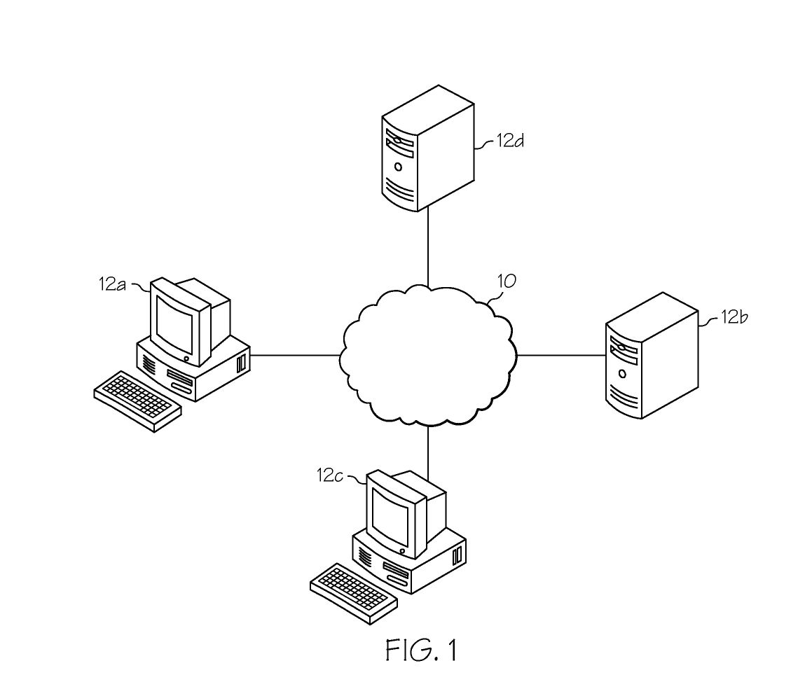

Referring now to the drawings, FIG. 1 depicts an exemplary computing network, illustrating components for a system for generating search queries that may be used to search the document corpus, according to embodiments shown and described herein. It should be understood that the computing network illustrated in FIG. 1 is provided as a non-limiting example only, as the embodiments described herein may be implemented in other computing network arrangements. As illustrated in FIG. 1, a computer network 10 may include a wide area network, such as the internet, a local area network (LAN), a mobile communications network, a public service telephone network (PSTN) and/or other network and may be configured to electronically connect a user computing device 12a, a server computing device 12b, and an administrator computing device 12c.

The user computing device 12a may be used to input one or more documents into an electronic document corpus as well as perform searching of the document corpus. The user computing device 12a may also be utilized to perform other user functions. Additionally, included in FIG. 1 is the administrator computing device 12c. In the event that the server computing device 12b requires oversight, updating, or correction, the administrator computing device 12c may be configured to provide the desired oversight, updating, and/or correction. The administrator computing device 12c, as well as any other computing device coupled to the network 10, may be used to input one or more documents into the electronic document corpus.

In one embodiment, the system further includes a semantic terms server 12d that is coupled to the network 10. The semantic terms server 12d may be configured as a server that receives search strings from the user computing device and/or the server computing device 12b, generates semantic terms based on the search strings using semantic terms logic and data, and provides semantic terms back to the server computing device 12b and/or the user computing device 12a. It is noted that semantic term generation will be described in more detail below.

It should be understood that while the user computing device 12a and the administrator computing device 12c are depicted as personal computers and the server computing device 12b is depicted as a server, these are nonlimiting examples. More specifically, in some embodiments any type of computing device (e.g., mobile computing device, personal computer, server, etc.) may be utilized for any of these components. Additionally, while each of these computing devices is illustrated in FIG. 1 as a single piece of hardware, this is also merely an example. More specifically, each of the user computing device 12a, server computing device 12b, and administrator computing device 12c may represent a plurality of computers, servers, databases, etc.

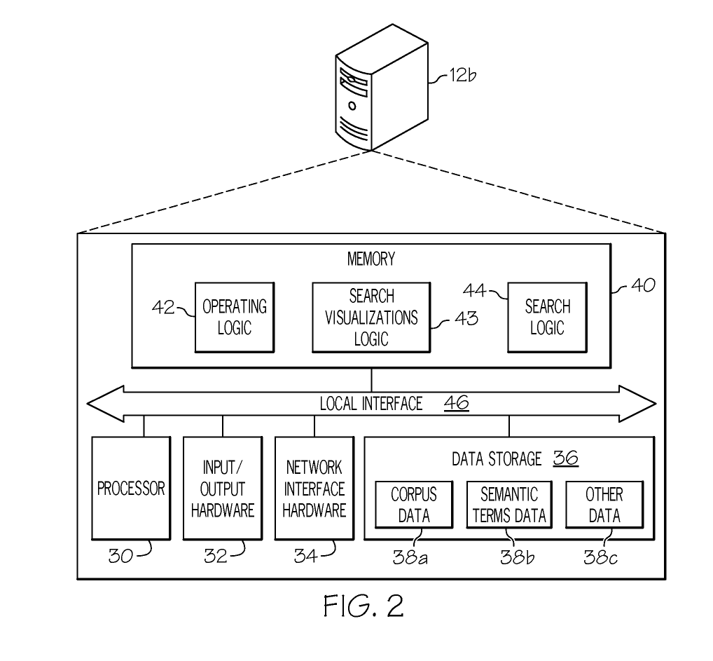

FIG. 2 depicts the server computing device 12b, from FIG. 1, further illustrating a system for searching a document corpus and graphically evaluating search queries, and/or a non-transitory computer-readable medium for searching a document corpus and/or graphically evaluating search queries embodied as hardware, software, and/or firmware, according to embodiments shown and described herein. While in some embodiments the server computing device 12b may be configured as a general purpose computer with the requisite hardware, software, and/or firmware, the server computing device 12b may be configured as a special purpose computer designed specifically for performing the functionality described herein.

As also illustrated in FIG. 2, the server computing device 12b may include a processor 30, input/output hardware 32, network interface hardware 34, a data storage component 36 (which may store corpus data 38a, semantic terms data 38b, and other data 38c), and a non-transitory memory component 40. The memory component 40 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 40 may be configured to store operating logic 42, search visualization logic 43, and search logic 44 (each of which may be embodied as a computer program, firmware, or hardware, as an example). A local interface 46 is also included in FIG. 2 and may be implemented as a bus or other interface to facilitate communication among the components of the server computing device 12b.

The processor 30 may include any processing component configured to receive and execute instructions (such as from the data storage component 36 and/or memory component 40). The input/output hardware 32 may include a graphic display device (e.g., a monitor), keyboard, mouse, printer, camera, microphone, speaker, touch-screen, and/or other user input device and output device for receiving, sending, and/or presenting data. The network interface hardware 34 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 36 may reside local to and/or remote from the server computing device 12b and may be configured to store one or more pieces of data for access by the server computing device 12b and/or other components. As illustrated in FIG. 2, the data storage component 36 may store corpus data 38a, which may include electronic documents (e.g., in at least one embodiment, patent documents such as issued patents and patent publications) that have been organized and indexed for searching. The corpus data 38a may be stored in one or more data storage devices. Similarly, semantic terms data 38b may be stored by the data storage component 36 and may include information relating to the generation of semantic search terms used in semantic searching. In another embodiment, the server computing device 12b may be coupled to a remote server or data storage device (e.g., semantics terms server 12d) that comprises the semantic terms data such that the semantic terms are generated remotely from the server computing device 12b. Other data 38c may be stored in the data storage component 36 to provide support for functionalities described herein (e.g., metadata that may be utilized in conjunction with the corpus data 38a to index the electronic documents stored within the document corpus).

Included in the memory component 40 are the operating logic 42, the search visualization logic 43, and the search logic 44. The operating logic 42 may include an operating system and/or other software for managing components of the server computing device 12b. Similarly, the search visualization logic 43 may reside in the memory component 40 and may be configured to generate the graphical representations of search query results described below. Also included in the memory component 40 and/or remotely from the server computing device 12b may be semantic terms logic that may facilitate electronic generation of the semantic terms from a provided search string. The search logic 44 may be configured to generate search queries from user-input within the graphical user interface, as described in detail below.

It should be understood that the components illustrated in FIG. 2 are merely exemplary and are not intended to limit the scope of this disclosure. More specifically, while the components in FIG. 2 are illustrated as residing within the server computing device 12b, this is a non-limiting example. In some embodiments, one or more of the components may reside external to the server computing device 12b. Similarly, while FIG. 2 is directed to the server computing device 12b, other components such as the user computing device 12a and the administrator computing device 12c may include similar hardware, software, and/or firmware.

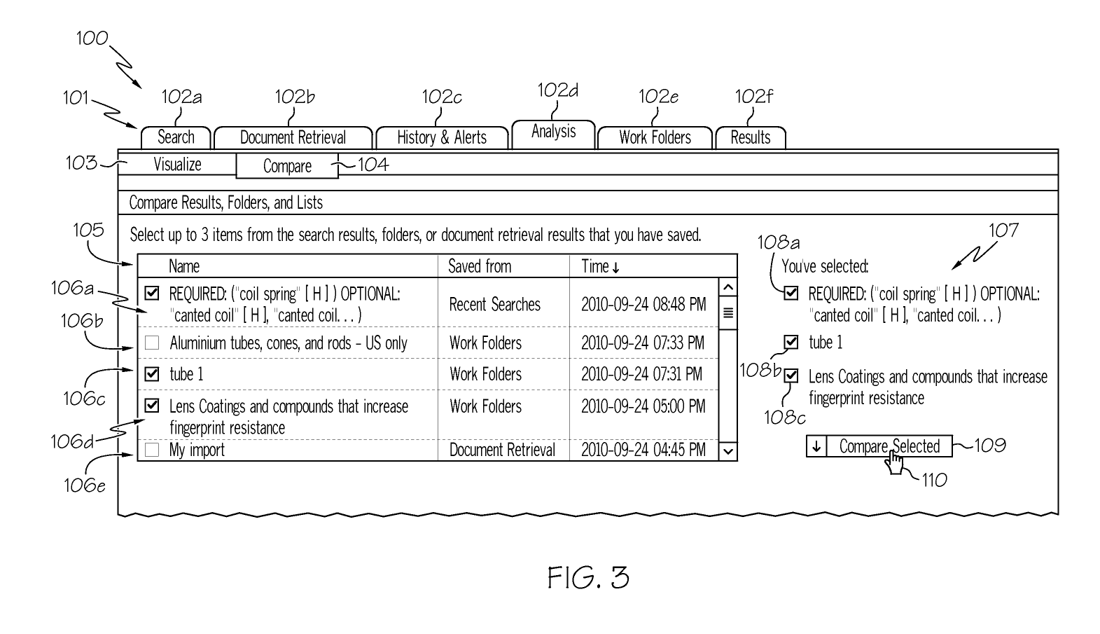

Referring now to FIG. 3, an exemplary graphical user interface 100 for searching electronic documents of a patent document corpus is illustrated. It should be understood that the icons, buttons, and arrangement of text of the graphical user interface 100 illustrated throughout the figures are provided herein as non-limiting examples. Other graphical user interface configurations are also possible. The graphical user interface 100 may be configured as web pages that are accessed by users over a network 10. In another embodiment, the graphical user interface 100 may be configured as screens of a program application (e.g., a program application accessed on a mobile computing device such as a tablet computer). The web page of the graphical user interface 100 depicted in FIG. 3 is a web page where a user may select previously saved search queries, as described in detail below.

The illustrated graphical user interface 100 has a tab bar 101 having a plurality of navigational tabs that may be clicked or otherwise selected by a user to access various functionalities of a search system. The tab bar 101 depicted in FIG. 3 includes a Search tab 102a that may be accessed by the user to search the document corpus, a Document Retrieval tab 102b for retrieving particular documents by citation, a History and Alerts tab 102c for viewing search histories and setting up notifications or alerts (e.g., when a patent issues, patent publications within a class, etc.), an Analysis tab 102d for comparing search results as described herein, a Work Folders tab 102e for retrieving previous searches and research, and a Results tab 102f for viewing the results of previous searches. It should be understood that the various tabs of the tab bar 101 are depicted as non-limiting examples. Further, embodiments are not limited to the names of the various tabs and buttons, as these names are used for illustrative purposes only. In the example depicted in FIG. 3, the Analysis tab 102d is selected to provide the user the ability to select and compare various search queries.

The graphical user interface 100 depicted in FIG. 3 displays a query list field 105 that lists various search queries (e.g., listed search queries 106a-106e) that are available for the user to select for graphical comparison. The query list field 105 may be generated upon a user selecting a Compare button 104, as a non-limiting example. The search queries may be previously saved search queries (e.g., saved in the Work Folders), recent search queries (e.g., the last 20 search queries or some other number of search queries), and search queries imported from another searching system. The search queries 106a-106e may be configured as any type of search query. For example, the search queries 106a-106e may be Boolean search queries, natural language search queries, semantic search queries, and others.

Semantic search queries incorporate semantic terms, which are terms that are semantically similar to the originally provided terms of a search string. Semantic searching may be beneficial by utilizing related terms that the user of the system would not otherwise include in his or her search string. In one embodiment, the individual terms of the search string are sent to a third party service that generates semantic terms based on the search string (e.g., PureDiscovery Corporation of Dallas, Tex.). In another embodiment, the semantic terms are generated within the server computing device 12b. Semantic terms may be generated by a variety of techniques.

The semantic terms logic may not only generate the semantic terms, but also create a Boolean weighted natural language search query (i.e., an initial search query) that is applied to the document corpus to return a set of returned electronic documents. The initial search query may also be configured as a type of search other than a Boolean weighted natural language search query. The initial search query may be generated using any number of query generation techniques. The returned semantic terms may then be used as the query terms.

In some embodiments, the user may select the search queries to compare by selecting a check box next to a name or description of the search query. For example, the graphical user interface 100 depicted in FIG. 3 indicates that the user selected search query 106a (which may be a recent Boolean search), search query 106c (which may be a saved semantic search), and search query 106d (which may be a natural language search). The graphical user interface 100 comprises a selected queries list 107 that lists the selected queries (e.g., listed search queries 108a-108c). The selected queries may be visually compared by selecting the Compare Selected button 109, as shown by mouse pointer 110.

In one embodiment, after a user selects the Compare Selected button 109, the search system may search the document corpus according to the parameters of the selected search queries. In the illustrated example, the three search queries 106a, 106c, and 106d, will generate a first document set, a second document set, and a third document set, respectively. Each document set comprises a plurality of electronic documents which, in the illustrated example, are patents and patent publications. Similar electronic documents may appear in two or more of the document sets.

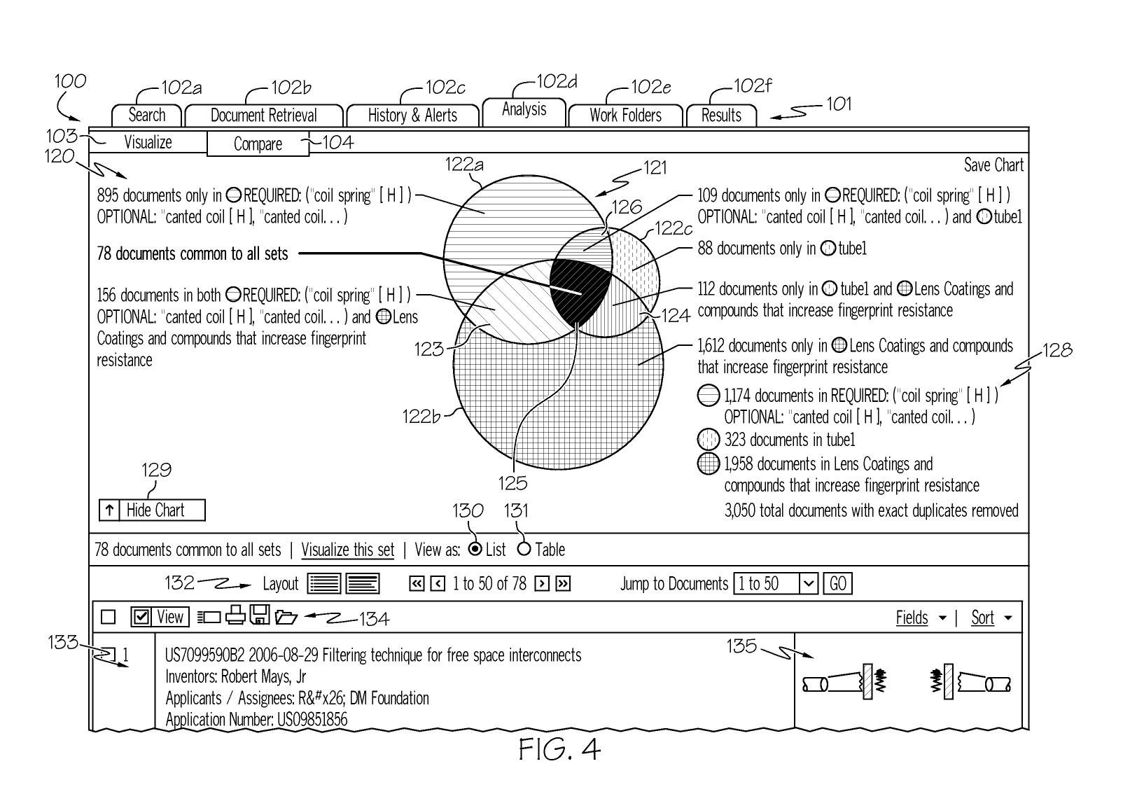

Referring now to FIG. 4, embodiments then generate a Venn diagram 121 that visually represents the document sets of the selected search queries. The screen (e.g., web page) of the graphical user interface 100 illustrated in FIG. 4 comprises a graphical search comparison region 120 that includes the Venn diagram 121 as well as text describing the various segments of the Venn diagram, and a results presentation region 133 that provides a preview of the electronic documents in a selected document set.

The exemplary Venn diagram 121 depicted in FIG. 4 comprises a circle for each search query that is being compared. Circle 122a corresponds to the document set resulting from search query 106a depicted in FIG. 3, while circle 122b corresponds to the document set resulting from search query 106d, and circle 122c corresponds to the document set resulting from search query 106c. The illustrated example also includes a legend 128 for interpreting the Venn diagram 121.

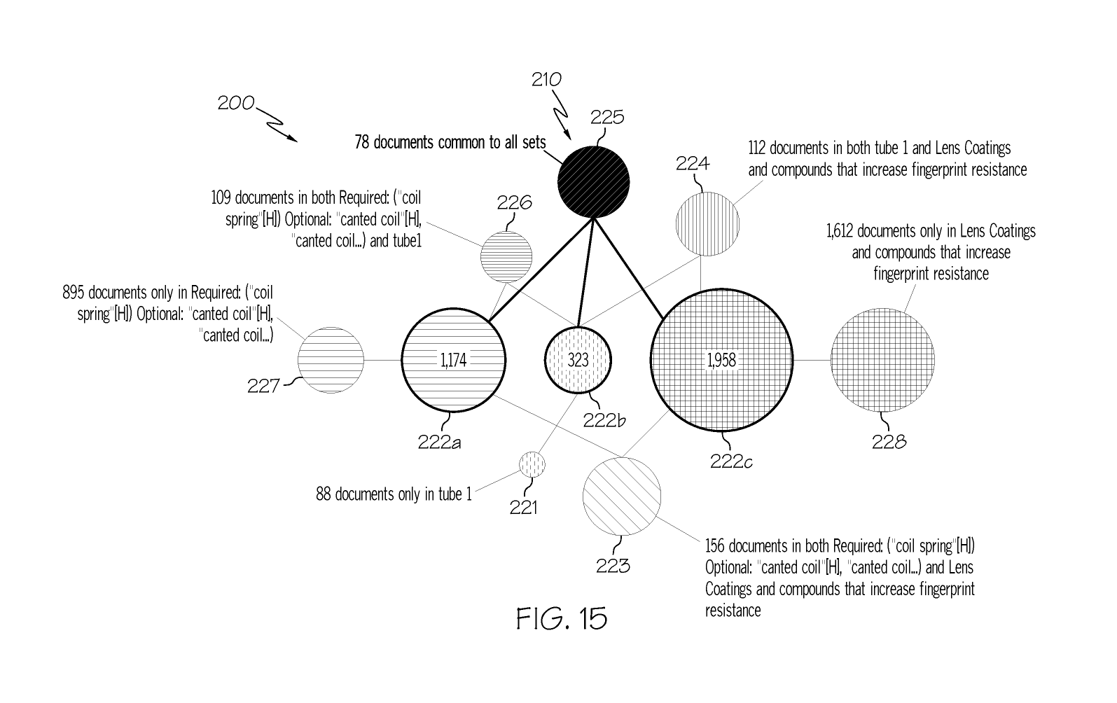

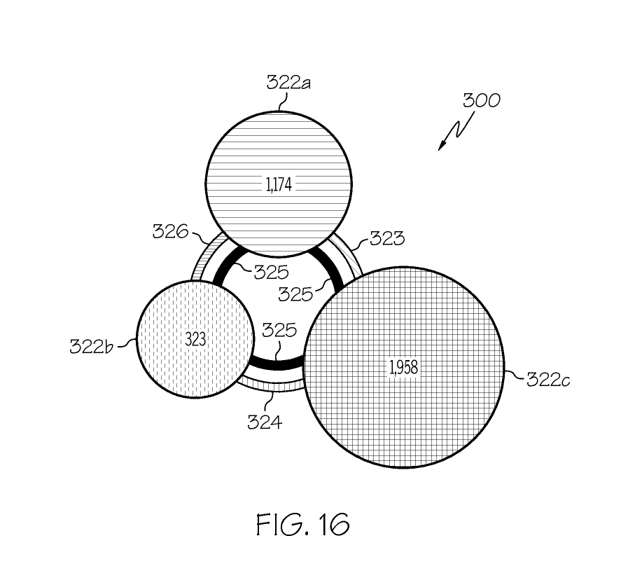

The size of the circle may correspond to the number of electronic documents within the document set. Although the Venn diagram comprises circles, other shapes may also be utilized. Further, three-dimensional shapes may be used to represent the document sets rather than two-dimensional shapes as shown in FIG. 4. The circles of the Venn diagram may have different formatting, such as color and/or hatch pattern. Alternative graphical representations of document sets are illustrated in FIGS. 15 and 16 and described below.

The Venn diagram 121 may comprise one or more overlap regions that indicate electronic documents appearing in two or more document sets. The size of the overlap regions may indicate relatively how many electronic documents appear in the two or more document sets. Further, the various overlap regions may have a formatting to differentiate the overlap from the remaining regions of the Venn diagram 121. In the illustrated example, overlap region 126 includes electronic documents that are present in both document sets resulting from search query 106a and 106c, overlap region 124 includes electronic documents that appear in both document sets resulting from search query 106c and 106d, and overlap region 125 includes electronic documents that appear in all three document sets. Each segment of the Venn diagram (i.e., overlap regions as well as regions of the Venn diagram that do not overlap) has text associated therewith that provides additional information as to the particular segment. For example, the text may indicate how many electronic documents are present in the segment and the search query or queries that generated the document set(s) associated with the segment.

In some embodiments, a particular segment or circle may be selected by the user to generate a preview of the electronic documents that are present within the selected segment. The preview of the electronic documents may be displayed in the results presentation region 133. As shown in FIG. 4, the segment represented by overlap region 125 is currently selected. It is noted that the format of overlap region 125 is such that the user knows that it is the segment that is currently selected. In the illustrated embodiment, the overlap region 125 has a particular diagonal hatch pattern to indicate selection. In other embodiments, the selected segment may be highlighted by use of a particular color, a particular hatch pattern, or both. It is noted that, in the present example, the text associated with the selected segment, which in the present case is overlap region 125, has a bold font to indicate that it is currently selected. In other embodiments, other text formatting may be used to indicate selection (e.g., color, italics, underlining, etc.), or the text may not comprise distinctive formatting.

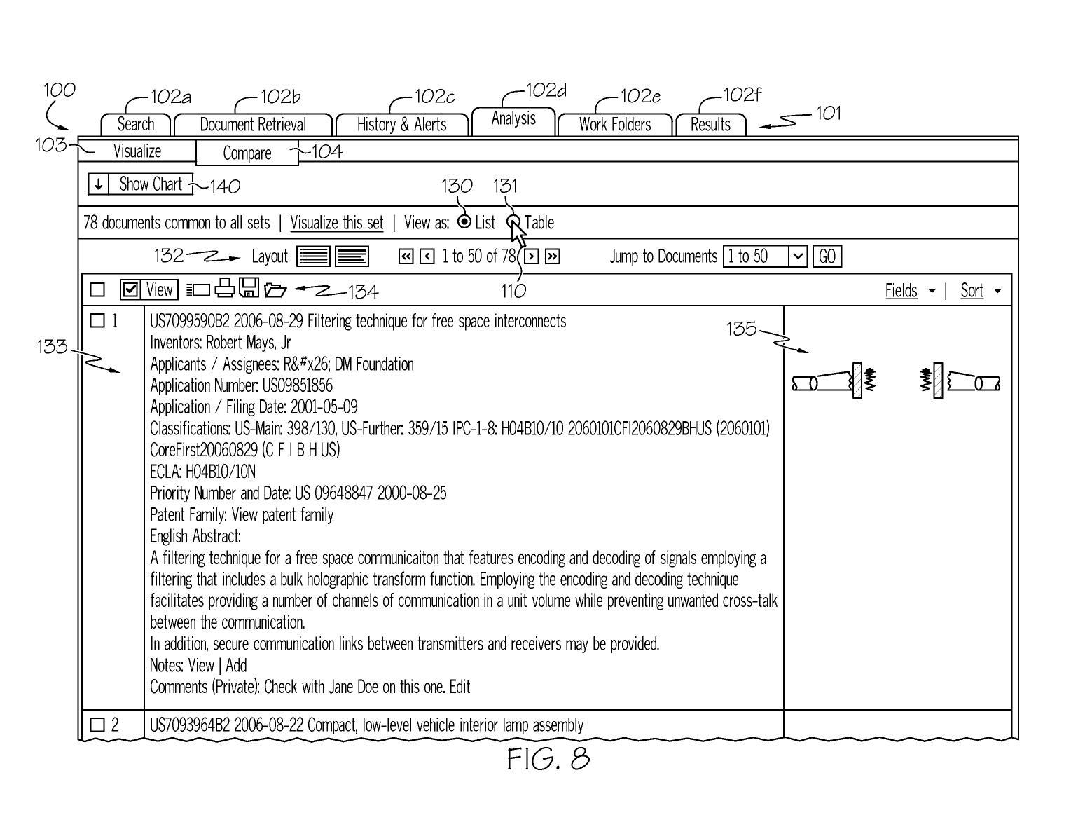

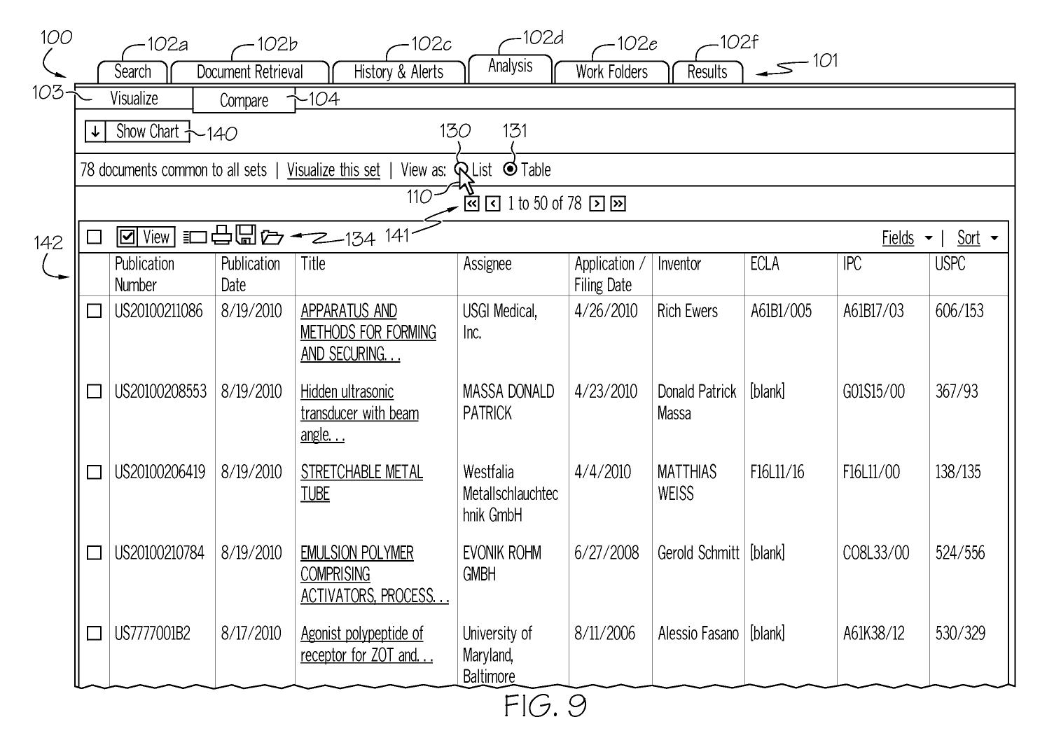

Referring generally to FIGS. 4-9, the exemplary screen of the graphical user interface 100 depicted in FIG. 4 also includes a Hide Chart button 129 that may hide the Venn diagram 121 from view. FIG. 8 depicts the graphical search comparison region 120 having been collapsed by selection of the Hide Chart button. As described above, the results presentation region 133 may display a preview of the electronic documents within the selected segment of the Venn diagram 121. The preview may include structured data associated various fields of the electronic documents (e.g., inventors, applicants/assignees, application number, application filing date, class/subclass, etc.) as well as one or more representative FIGS. 135. The view of the electronic documents in the results presentation region 133 may be controlled by the List 130 and Table 131 radio buttons. FIGS. 4-8 depict the results presentation region 133 in List mode, while FIG. 9 depicts the results presentation region in Table mode. In Table mode, the electronic documents are provided in a table 142 that includes various document parameters (e.g., publication number, publication date, title, and the like). A user may navigate the electronic documents in the results presentation region 133 by use of a navigation bar 132, where he or she may jump to particular documents, and scroll backward and forward between electronic documents. Further, the electronic documents in the results presentation region 133 may be manipulated using a toolbar 134. The toolbar 134 may provide functionality such as saving, printing e-mailing, and opening one or more selected electronic documents. Additional functionality may also be provided, such as sorting of the order of the electronic documents. The user may view the chart again by selecting the View Chart button 140.

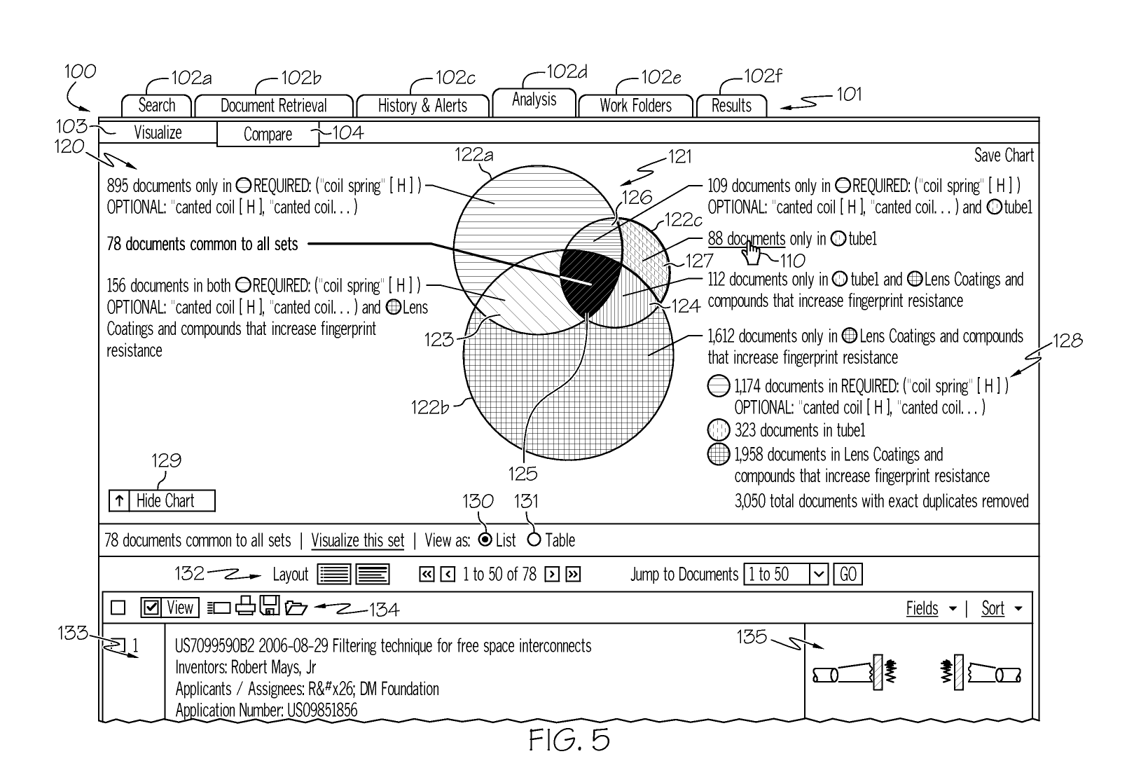

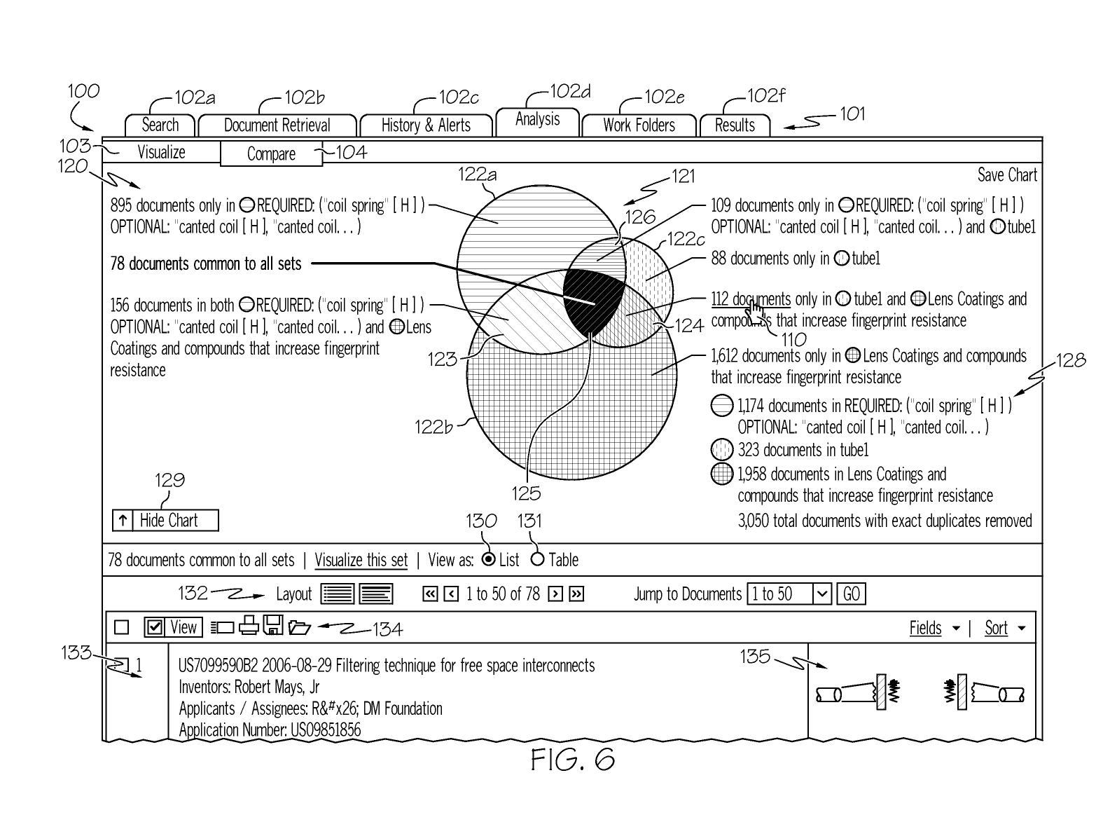

Referring now to FIG. 5, a user action, such as a hovering action of a mouse pointer 110 over a particular segment or text associated with a particular segment, may change the format of the particular segment such that it is highlighted and stands out amongst the remaining segments of the Venn diagram 121. In the example depicted in FIG. 5, the user has hovered the mouse pointer 110 over the text associated with the segment 127 of circle 122c that contains electronic documents that are only found in the document set associated with search query 106c. It is noted that the hatch pattern of segment 127 has changed such that it is highlighted to differentiate it from the remaining segments. In FIG. 6, the overlap region 124 is highlighted because the mouse pointer 110 is hovered over the text associated with overlap region 124. A segment may also be highlighted by hovering the mouse pointer 110 over the actual segment rather than the text associated therewith.

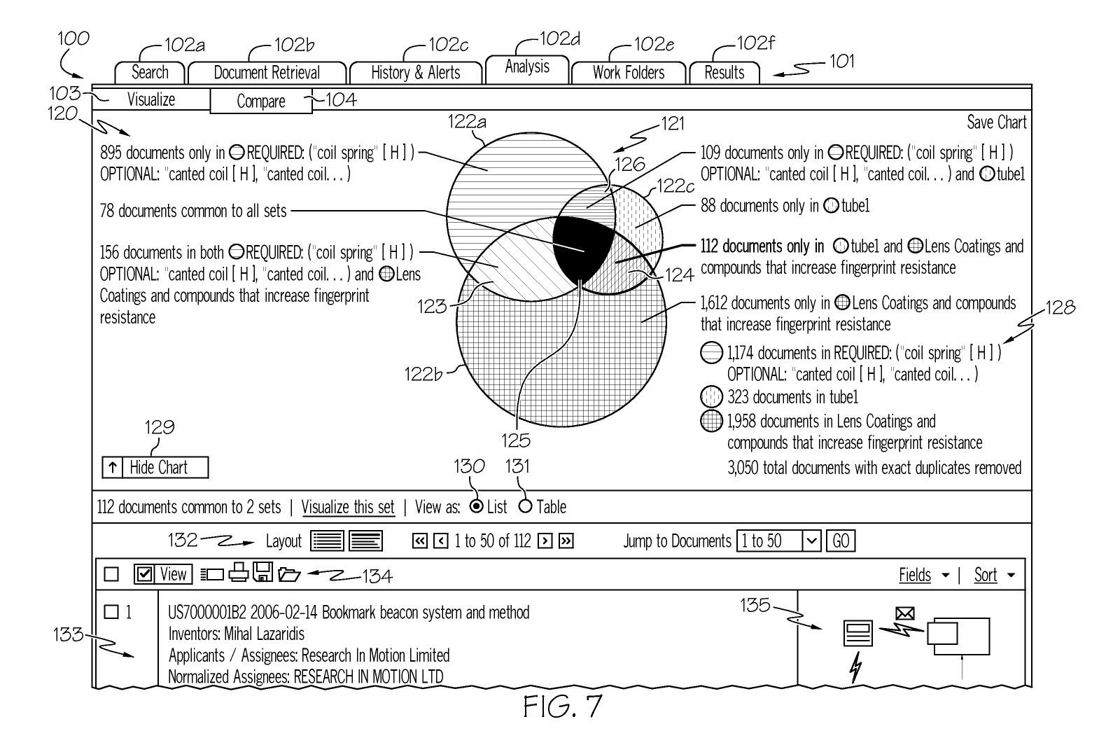

To change the selected segment, and therefore the document set previewed in the results presentation region 133, a user may click or otherwise select the desired segment or the text associated with the desired segment. Referring now to FIG. 7, the user has clicked or otherwise selected the text associated with overlap region 124. In response to this user input, the text associated with overlap region 124 is now bold, and the format of the segment associated with overlap region 124 has changed to indicate that it is the currently selected segment. It is noted that the overlap region 124 now has a hatch pattern that is the same as overlap region 125 in FIG. 6. Again, the formatting that indicates segment selection is not limited to any particular hatch pattern or color, as other formatting techniques may be used. For example, in some embodiments, the selected segment may be slightly lifted above the remaining segments of the Venn diagram 121 to indicate selection. Because overlap region 124 has been selected, the electronic documents depicted in the results presentation region 133 have changed from those electronic documents associated with the document set of overlap region 125 to those electronic documents associated with the document set of overlap region 124. As such, the first patent document that is previewed in the results presentation region 133 in FIG. 7 is different than the first patent document previewed in FIG. 6.

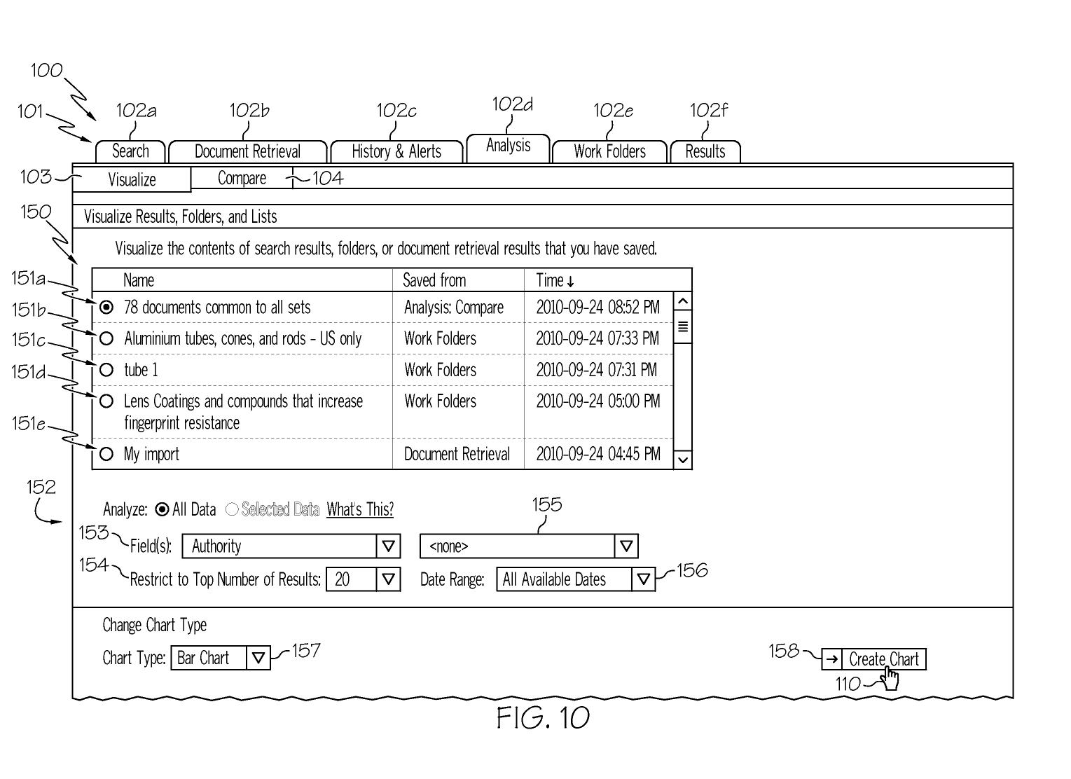

In some embodiments, the system may provide the ability for a user to further visualize the document sets resulting from the one or more search queries. FIG. 10 illustrates a screen of the graphical user interface 100 wherein the Visualize button 103 has been selected to display a visualization selection region 150. The visualization selection region 150 may be provided to select a document set (e.g., document sets 151a-151e) to further visualize according to one or more user-defined parameters. User-defined parameters are any parameters that may be selected by a user or provided automatically by the search system, such as a default parameter. The document sets may result from previously saved search queries, imported queries, as well as those document sets resulting from the search query comparison depicted in the Venn diagram, such as document set 151a, which corresponds to overlap region 125 of the Venn diagram. A user may select the desired document set, such as by selecting a radio button associated with the desired document set.

Additionally, the Venn diagrams depicted in FIGS. 4-10 may also be manipulated by applying user-defined parameters as filter terms to change the size and relative overlap of the document sets. For example, a user may use structured field data as one or more user-defined parameters to narrow down the document sets. As an example and not a limitation, a user may choose to visualize only those documents that are related to a specific class or specific authority.

The screen of the graphical user interface 100 depicted in FIG. 10 also includes a filter region 152 that comprises a plurality of user-defined parameters for which a user may select to filter the document set. The plurality of user-defined parameters may include structured data fields of the electronic documents within the document set, which may be selected using Field drop-down box 153 as a non-limiting example. The structured data fields may include fields particular to the type of documents within the document set. In the patent document context, the structured data fields may include, but are not limited to, authority, assignee, class/subclass, inventor, attorney/agent, and the like. An additional structured data field may also be selected in the additional drop-down box 155, for example. Further, other filtering parameters may also be provided, such as a number of result restriction 154 and a date range restriction 156. In some embodiments, the user may select the type of chart that he or she wishes to use to visualize the selected document set. Any chart may be provided, such as, but not limited to, bar charts, pie charts, line charts, and the like. After the user is satisfied with his or her selections, the desired chart may be generated to depict the selected document set according to the desired user-defined parameters by selecting the Create Chart button 158.

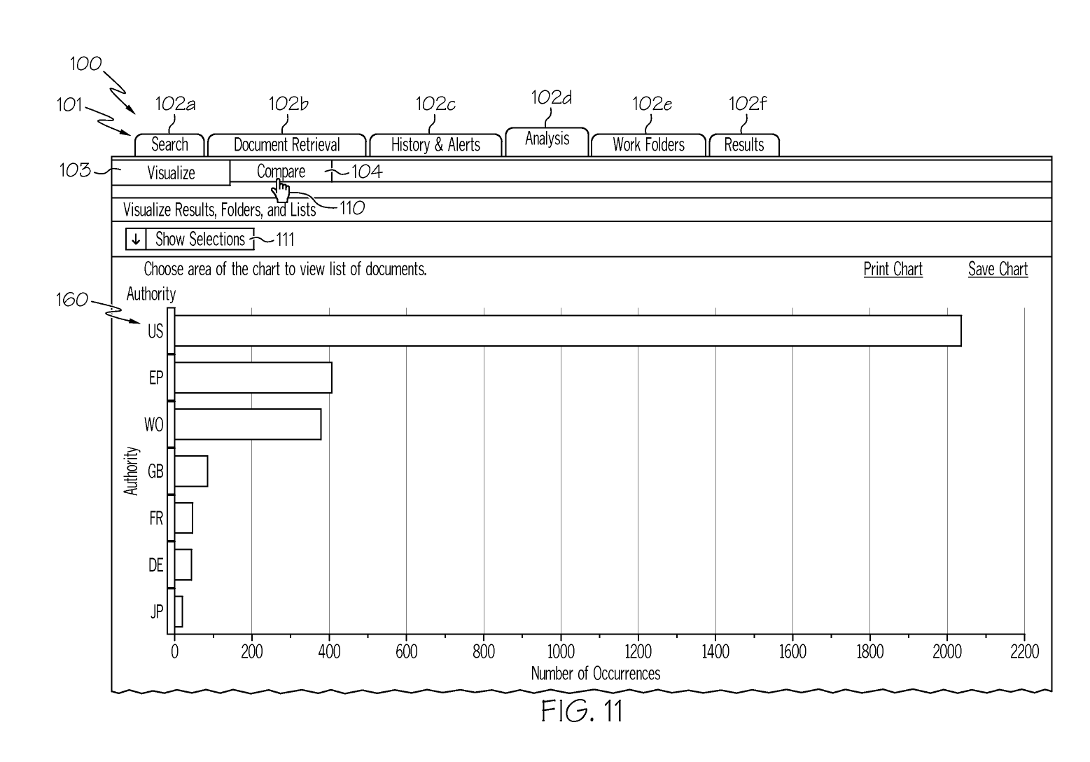

FIG. 11 depicts an exemplary visualization chart 160 configured as a bar chart that depicts the document set represented by the overlap region 125 broken down by the authority user-defined parameter. It should be understood that other user-defined parameters, such as structured field data, may be used to create various visualization charts.

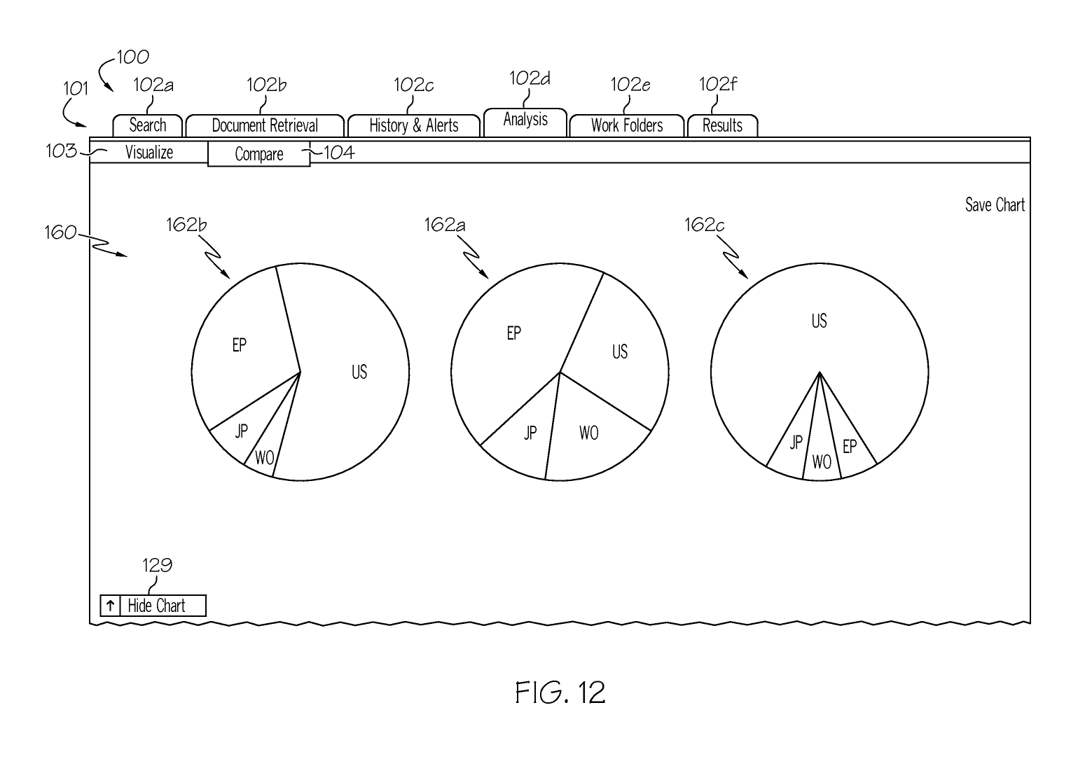

The document sets may be filtered and visualized in other manners as well. FIG. 12 depicts three visualization charts 162a-162c corresponding to overlapping segments 124-126 of the Venn diagram 121, respectively. The visualization charts 162a-162c break down the document sets corresponding to the selected search queries by a user-defined parameter, such as authority as shown in FIG. 12. Other user-defined parameters may also be used as described above. A user may create the visualization charts 162a-162c in a variety of ways. Referring to both FIGS. 4 and 12, the user may select and drag a segment away from the Venn diagram 121 to dynamically create the individual visualization charts 162a-162c. In this manner, the overlapping document sets may be compared in a side-by-side visualization of the contents within such document sets.

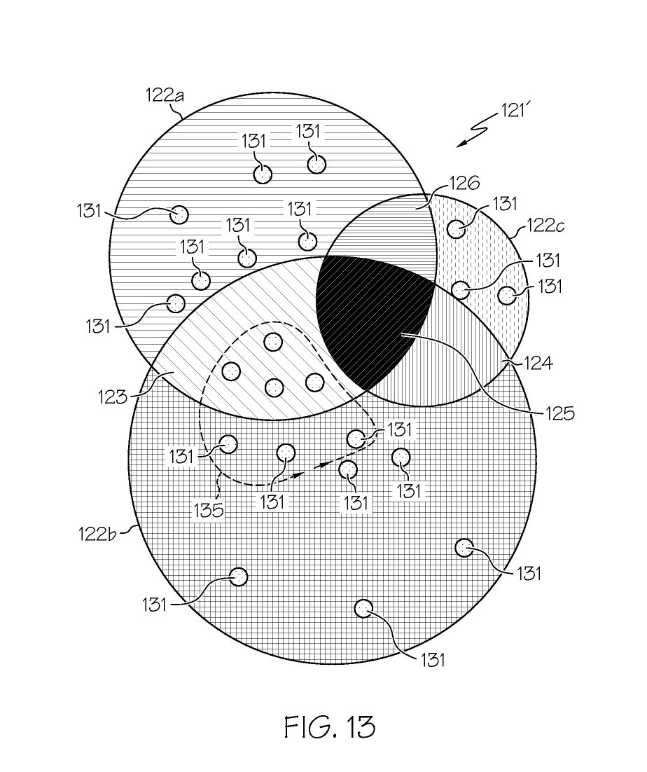

The semantic analysis features of the electronic document searching system and/or the structured field data of the electronic documents within the document corpus may allow for embodiments to plot not only which documents are inside and outside particular document sets within the Venn diagram as described above, but also to plot which documents are close to each other semantically and/or close to each other according to structured field data of the electronic documents, such as authority, inventor, filing date, and the like. FIG. 13 depicts an exemplary Venn diagram 121′ that further plots electronic documents (represented by circles 131) according to one or more user-defined parameters, such as semantic similarity to terms or structured field data of the electronic documents. Electronic documents that are close together in a cluster indicate that the electronic documents are similar to one another according to the user defined parameter, irrespective of which document set the clustered electronic documents appear, and whether or not the electronic documents are present within an overlap region.

The graphical representation of the electronic documents according to the embodiment illustrated in FIG. 13 may take on a variety of forms. In the illustrated embodiment, each electronic document is graphically represented by a circle 131. However, other icons may be utilized. Further, the graphical representation of the electronic documents may be formatted by color to provide colored circles that indicate which user-defined parameter the particular electronic documents possess. As an example and not a limitation, a user may define a first user-defined parameter as a semantic similarly to a particular term and a second user-defined parameter as a particular authority. The graphical representations of the electronic documents corresponding to the first user-defined parameter may be icons of a first color (e.g., blue) and the graphical representations of the electronic documents corresponding to the second user-defined parameter may be icons of a second color (e.g., red). Electronic documents satisfying both first and second user-defined parameters may also have a particular format (e.g., a mixture of the first color and the second color, such as purple).

As shown in FIG. 13, groups of electronic documents may be clustered around borders of the Venn diagram 121′. This may allow a user to visualize which documents are similar to each other even if they are opposite sides of a boundary. Embodiments may also allow a user to select one or more clusters of electronic documents to generate one or more new document sets. For example, a user may select one or more clusters of electronic documents by creating a perimeter 135 around the graphical representations of the electronic documents of interest using a mouse pointer or other input device. Selection of one or more clusters may then create a new document set based on the user-defined parameter(s) exhibited by the selected electronic documents. Such new document sets may cross boundaries and terms in ways not previously possible. The new document sets may be represented by a new Venn diagram, a listing of the electronic documents within the new document sets, or both.

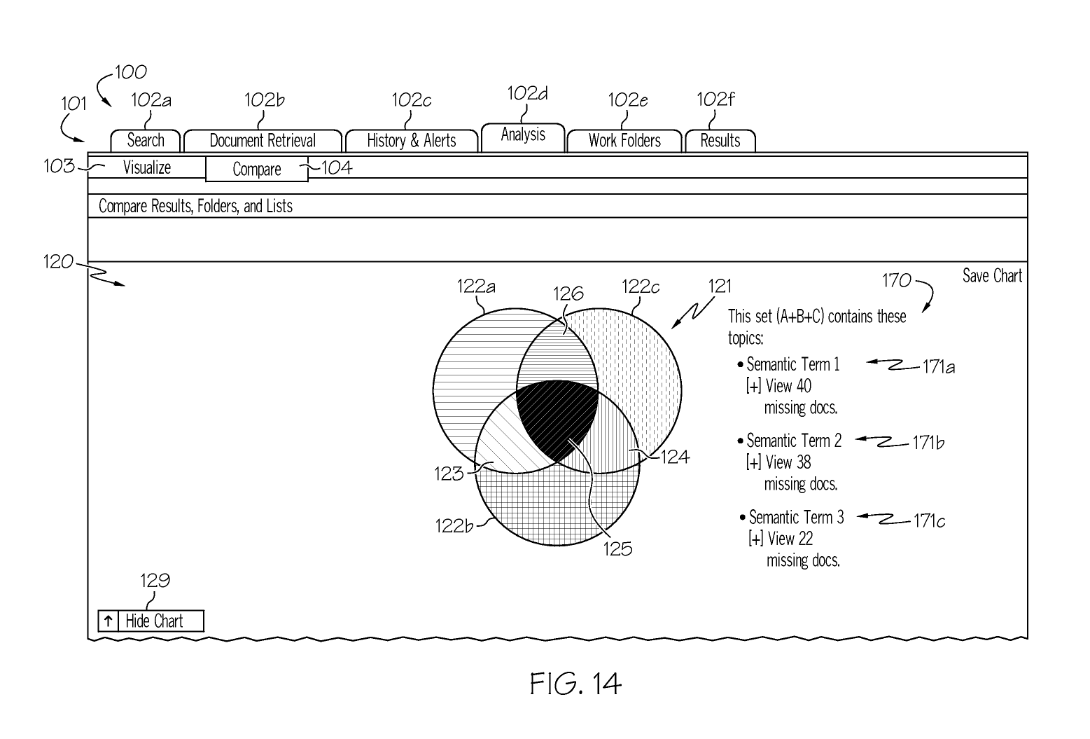

The graphical representations of search queries may not only be used to analyze prior searches, but also as a tool to create new search queries based on prior search results. FIG. 14 illustrates an embodiment that recommends new search queries based on semantically similar terms (i.e., common terms) that were found within a selected segment of the Venn diagram 121. In the illustrated embodiment, in response to a user selecting overlap region 125, a suggested terms list 170 is generated that lists one or more suggested terms 171a-171c. The suggested terms 171a-171c may be generated by a semantic analysis of the electronic documents within the selected region. Embodiments may use semantic analysis to determine which topics are most prevalent in the selected segment, and then suggest additional documents that are semantically similar, but were not found by the search terms used for any of the original search queries represented by the Venn diagram 121. For example, additional search queries may be automatically generated based on the most prevalent topics within the electronic documents of the selected segment. The results of these new search queries may be summarized in the suggested terms list 170. The semantic term representing the particular topic may be displayed along with a number of missing documents (additional documents that were found that are outside of the displayed Venn diagram 121) and a link to those missing documents. Any number of suggested terms 171a-171c may be provided in the topics list 170. Accordingly, embodiments may enable new searches to find additional electronic documents of interest that were not found by the original search queries.

FIGS. 15 and 16 depict exemplary graphical representations of search result sets other than a Venn diagram. Referring specifically to FIG. 15, a graphical representation 200 comprises three circles 222a-222c that represent a document set associated with a search query. Each circle 222a-222c may be sized according to the number of electronic documents in the particular document set. As an example and not a limitation, the first circle 222a may correspond with a document set resulting from the first selected search query 106a illustrated in FIG. 3, while the second circle 222b may correspond with a document set resulting from the second selected search query 106c, and the third circle may correspond with a document set resulting from the third selected search query 106d. The graphical representation may also comprise additional circles that represent electronic documents that appear in two or more of the document sets depicted by circles 222a-222c, or electronic documents that appear in only one of the original document sets depicted by circles 222a-222c. These additional circles represent information similar to the overlapping regions of the Venn diagram depicted in FIG. 4. As an example and not a limitation, circle 227 depicts electronic documents contained only in the document set corresponding with the first selected search query 106a represented by first circle 222a. Circle 226 depicts electronic documents contained in document sets corresponding with the first selected search query 106a, and the second selected search query 106c represented by first circle 222a and second circle 222b. Circle 225 depicts electronic documents contained in all of the document sets represented by the first circle 222a, the second circle 222b, and the third circle 222c. Circles 221, 223, 226, 224, and 228 may represent similar relationships. It should be understood that shapes other than circles may be utilized to represent the various document sets, and more or fewer original circles resulting from the search queries may be utilized depending on the number of search queries.

In one embodiment, a user may select one or more of the circles such that it and all of the connected circles are highlighted so that they are easily visible to the user. In the illustrated embodiment, the user has selected circle 225, which is formatted by a hatch pattern to indicate that it is currently selected. Further, circles 222a-222c are also bold or otherwise formatted to emphasis their connection to selected circle 225.

Referring now to FIG. 16, an exemplary graphical representation 300 of search results according to another embodiment is illustrated. The graphical representation 300 of FIG. 16 comprises three circles: first circle 322a, second circle 322b and third circle 322c. As an example and not a limitation, the three circles 322a-322c may represent the document sets resulting from the search queries 106a, 106c and 106d depicted in FIG. 3, as described above with respect to FIG. 15. The graphical representation 300 also comprises ring portions 323-326 that link the three circles 322a-322c and graphically illustrate document sets that include electronic documents resulting from two or more of the document sets represented by the three circles 322a-322c. The ring portions 323-326 may be formatted to depict which of the circles 322a-322c they are associated with. For example, ring portion 326 represents electronic documents in the document sets depicted by the first circle 322a and the second circle 322b, while ring portions 325 represent electronic document in the document sets depicted by all three circles 322a-322c. A user may select or highlight the circles 322a-322c and the ring portions 323-326 to perform the various functionalities described above, such as preview the electronic documents, further visualize the selected document sets, and the like.

It should be understood that embodiments described herein enable users of an electronic document search system to visually analyze the results of various search strategies. In some cases, the user may be interested in seeing what additional cases a semantic search may find over a Boolean search, for example. The user may select a segment of a Venn diagram that includes those documents found in the semantic search only, so that he or she does not waste researching time evaluating documents multiple times. The Venn diagram may assist the user in determining the completeness of his or her search. Embodiments may also allow a user to graphically represent documents within the Venn diagram that satisfy particular user-defined parameters, and to generate new document sets based on clusters of electronic documents. Further, embodiments may enable new search queries to be generated that are based on topics found within one or more segments of the Venn diagram.

It should also be understood that the present disclosure includes various aspects.

In a first aspect, the disclosure provides a method of graphically representing an electronic document search, the method comprising: receiving at least a first search query and a second search query; searching an electronic document database using the first search query and the second search query to obtain a first document set based on the first search query and a second document set based on the second search query, wherein the first document set comprises a first plurality of electronic documents and the second document set comprises a second plurality of electronic documents; generating a Venn diagram for display on a graphic display device, the Venn diagram comprising a first circle that represents the first document set and a second circle that represents the second document set, wherein: a size of the first circle and the second circle reflect a number of documents in the first document sent and the second document set, respectively; and the first circle overlaps the second circle in an overlap region, the overlap region depicting common electronic documents that are within the first document set and the second document set.

In a second aspect, the disclosure provides a computer program product for use with a graphic display device, the computer program product comprising: a computer usable medium having computer readable program code embodied on the computer usable medium, the computer readable program code comprising: computer readable code instructions for receiving at least a first search query and a second search query; computer readable code instructions for searching an electronic document database using the first search query and the second search query to obtain a first document set based on the first search query and a second document set based on the second search query, wherein the first document set comprises a first plurality of electronic documents and the second document set comprises a second plurality of electronic documents; computer readable code instructions for generating a Venn diagram for display on a graphic display device, the Venn diagram comprising a first circle that represents the first document set and a second circle that represents the second document set, wherein: a size of the first circle and the second circle reflect a number of documents in the first document sent and the second document set, respectively; and the first circle overlaps the second circle in an overlap region, the overlap region depicting common electronic documents that are within the first document set and the second document set.

In a third aspect, the disclosure provides the method of the first aspect or the computer program product of the second aspect, further comprising separating the first circle from the second circle on the graphic display device in response to a user input, and generating a first chart from the first circle and a second chart from the second circle, wherein the first chart and the second chart depict proportions of the first document set and the second document set according to a structured data field.

In a fourth aspect, the disclosure provides any of the first through third aspects, further comprising identifying electronic documents in the first document set and the second document set satisfying at least one user-defined parameter; and populating the first circle and the second circle with a plurality of graphical representations of electronic documents satisfying the at least one user-defined parameter, wherein a first portion of the plurality of graphical representations is located within the first circle near a second portion of the plurality of graphical representations located within the second circle.

In a fifth aspect, the disclosure provides any of the first through fourth aspects, further comprising: determining one or more semantically similar topics of the electronic documents within the overlap region; generating one or more additional search queries based on the one or more semantically similar topics; searching the electronic database using the one or more additional search queries to obtain one or more search result sets, and displaying one or more visual representations of one or more search result sets using the one or more additional search queries.

In a sixth aspect, the disclosure provides any of the first through fifth aspects, wherein the first search query comprises a semantic search query and the second search query is a Boolean search query.

In a seventh aspect, the disclosure provides any of the first through sixth aspects, further comprising displaying text describing the electronic documents within the first circle, the second circle, and the overlap region.

In an eighth aspect, the disclosure provides any of the first through seventh aspects, further comprising, in response to a user input, generating a graph of the electronic documents within the first circle, the second circle, or the overlap region, wherein the graph represents the electronic documents sorted by one or more structured data fields.

In a ninth aspect, the disclosure provides any of the first through eighth aspects, further comprising altering the size of the first circle and/or the second circle based on one or more user-defined filter terms, wherein the one or more user-defined filter terms filter the electronic documents of the first document set and/or the second document set.

In a tenth aspect, the disclosure provides any of the first through ninth aspects, further comprising altering a format of the first circle, the second circle, or the overlap region in response to a user-selection.

In an eleventh aspect, the disclosure provides any of the first through tenth aspects, wherein the user-selection is a hover action of a mouse icon over the first circle, the second circle or the overlap region.

In a twelfth aspect, the disclosure provides the eleventh aspect, wherein altering the format comprises altering a hatch pattern of the first circle, the second circle, or the overlap region.

In a thirteenth aspect, the disclosure provide any of the third through twelfth aspects, further comprising, in response to a user input, generating a visualization chart of electronic documents within the first circle, the second circle, or the overlap region, wherein the visualization chart of electronic documents represents the electronic documents sorted by one or more user-defined parameters.

In a fourteenth aspect, the disclosure provides any of the third through thirteenth aspects, further comprising altering the size of the first circle and/or the second circle based on one or more user-defined filter terms, wherein the one or more user-defined filter terms filter electronic documents of the first document set and/or the second document set.

In a fifteenth aspect, the disclosure provides any of the third through fourteenth aspects, further comprising altering a format of the first circle, the second circle, or the overlap region in response to a user-selection.

In a sixteenth aspect, the disclosure provides the fifteenth aspect, wherein the user-selection is a hovering action of a mouse pointer over the first circle, the second circle or the overlap region.

In a seventeenth aspect, the disclosure provides the fifteenth aspect, wherein altering the format comprises altering a hatch pattern of the first circle, the second circle, or the overlap region.

In an eighteenth aspect, the disclosure provides any of the fourth through seventeenth aspects, wherein the at least one user-defined parameter comprises a semantic similarity to one or more terms, and/or a type of structured data field.

In a nineteenth aspect, the disclosure provides for the eighteenth aspect, wherein the first and second plurality of electronic documents are patent documents, and the type of structured data field comprises one or more of the following: inventor name, class, subclass, authority, title, claims, assignee, and filing date.

In a twentieth aspect, the disclosure provides any of the fourth through nineteenth aspects, wherein the plurality of graphical representation of electronic documents comprises colored circles.

In a twenty-first aspect, the disclosure provides any of the fourth through twentieth aspects, further comprising providing an ability for a user to select a portion of the first circle, the second circle, and/or the overlap region corresponding to at least a portion of the plurality of graphical representations of electronic documents.

In a twenty-second aspect, the disclosure provides any of the fourth through twenty-first aspects, further comprising, in response to a user selecting a selected portion of the first circle, the second circle, and/or the overlap region corresponding to at least a portion of the plurality of graphical representations, listing electronic documents that are included within the selected portion.

In a twenty-third aspect, the disclosure provides any of the fourth through twenty-second aspects, further comprising, in response to a user selecting a selected portion of the first circle, the second circle, and/or the overlap region corresponding to at least a portion of the plurality of graphical representations of electronic documents, depicting a second Venn diagram including the selected portion of the Venn diagram.

In a twenty-fourth aspect, the disclosure provides any of the fifth through twenty-third aspects, wherein the one or more visual representations indicate a number of electronic documents within the one or more search result sets.

In a twenty-fifth aspect, the disclosure provides any of the fifth through twenty-fourth aspects, wherein user selection of the one or more visual representations generates a preview of electronic documents within the selected visual representation of electronic documents.

In a twenty-sixth aspect, the disclosure provides any of the fifth through twenty-fifth aspects, wherein one or more electronic documents within the one or more additional document sets are not contained in the first document set and the second document set.

In a twenty-seventh aspect, the disclosure provides any of the fifth through twenty-sixth aspects, wherein determining one or more semantically similar terms comprises identifying one or more common terms within electronic documents contained in the overlap region, generating semantic terms that are semantically similar to the one or more common terms, and identifying common semantic terms within the electronic documents contained in the overlap region.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method of graphically representing electronic document searches, the method comprising:
receiving at least a first search query and a second search query;
searching an electronic document database using the first search query and the second search query to obtain a first document set based on the first search query and a second document set based on the second search query, wherein the first document set comprises a first plurality of electronic documents and the second document set comprises a second plurality of electronic documents;
generating, by a computer, a Venn diagram for display on a graphic display device, the Venn diagram comprising a first circle that represents the first document set and a second circle that represents the second document set, wherein:
a size of the first circle and the second circle reflect a number of electronic documents in the first document set and in the second document set, respectively; and
the first circle overlaps the second circle in an overlap region, the overlap region depicting common electronic documents that are within the first document set and the second document set; and
depicting a separation of the first circle from the second circle on the graphic display device in response to a user input, and generating a first visualization chart from the first circle and a second visualization chart from the second circle, wherein the first visualization chart and the second visualization chart depict proportions of the first document set and the second document set according to a user-defined parameter.

2. The method as claimed in claim 1, wherein the first search query comprises a semantic search query and the second search query is a Boolean search query.

3. The method as claimed in claim 1, wherein the user-defined parameter corresponds to a type of structured data field.

4. The method as claimed in claim 1, wherein the user input is provided by dragging at least one of the first circle and the second circle with a user input device to separate the first circle from the second circle.

5. The method as claimed in claim 1, further comprising, in response to a user input, generating a visualization chart of electronic documents within the first circle, the second circle, or the overlap region, wherein the visualization chart of electronic documents represents the electronic documents sorted by one or more user-defined parameters.

6. The method as claimed in claim 1, further comprising altering the size of the first circle and/or the second circle based on one or more user-defined filter terms, wherein the one or more user-defined filter terms filter electronic documents of the first document set and/or the second document set.

7. The method as claimed in claim 1, further comprising:
identifying electronic documents in the first document set and the second document set that satisfy at least one user-defined parameter; and
populating the first circle and the second circle with a plurality of graphical representations of electronic documents satisfying the at least one user-defined parameter, wherein a first portion of the plurality of graphical representations of electronic documents is located within the first circle near a second portion of the plurality of graphical representations of electronic documents located within the second circle.

8. The method as claimed in claim 1, further comprising:
determining one or more semantically similar terms of electronic documents within the overlap region;
generating one or more additional search queries based on the one or more semantically similar terms;
searching the electronic document database using the one or more additional search queries to obtain one or more additional document sets; and
displaying one or more visual representations of one or more search result sets using the one or more additional search queries.

9. A method of graphically representing electronic document searches, the method comprising:
receiving at least a first search query and a second search query;
searching an electronic document database using the first search query and the second search query to obtain a first document set based on the first search query and a second document set based on the second search query, wherein the first document set comprises a first plurality of electronic documents and the second document set comprises a second plurality of electronic documents;
identifying electronic documents in the first document set and the second document set that satisfy at least one user-defined parameter;
generating a Venn diagram for display on a graphic display device, the Venn diagram comprising a first circle that represents the first document set and a second circle that represents the second document set, wherein:
a size of the first circle and the second circle reflect a number of electronic documents in the first document set and in the second document set, respectively; and
the first circle overlaps the second circle in an overlap region, the overlap region depicting common electronic documents that are within the first document set and the second document set; and
populating the first circle and the second circle with a plurality of graphical representations of electronic documents satisfying the at least one user-defined parameter, wherein a first portion of the plurality of graphical representations of electronic documents is located within the first circle near a second portion of the plurality of graphical representations of electronic documents located within the second circle.

10. The method as claimed in claim 9, wherein the first and second plurality of electronic documents are patent documents, and the type of structured data field comprises one or more of the following: inventor name, class, subclass, authority, title, claims, assignee, and filing date.

11. The method as claimed in claim 9, further comprising, in response to a user selecting a selected portion of the first circle, the second circle, and/or the overlap region corresponding to at least a portion of the plurality of graphical representations, listing electronic documents that are included within the selected portion.

12. The method as claimed in claim 9, further comprising, in response to a user selecting a selected portion of the first circle, the second circle, and/or the overlap region corresponding to at least a portion of the plurality of graphical representations of electronic documents, depicting a second Venn diagram including the selected portion of the Venn diagram.

13. The method as claimed in claim 9, further comprising, in response to a user input, generating a visualization chart of electronic documents within the first circle, the second circle, or the overlap region, wherein the visualization chart of electronic documents represents the electronic documents sorted by one or more structured data fields.

14. A method of electronic document searching, the method comprising:
receiving at least a first search query and a second search query;
searching an electronic document database using the first search query and the second search query to obtain a first document set based on the first search query and a second document set based on the second search query, wherein the first document set comprises a first plurality of electronic documents and the second document set comprises a second plurality of electronic documents;
generating a Venn diagram for display on a graphic display device, the Venn diagram comprising a first circle that represents the first document set and a second circle that represents the second document set, wherein:
a size of the first circle and the second circle reflect a number of electronic documents in the first document set and in the second document set, respectively; and
the first circle overlaps the second circle in an overlap region, the overlap region depicting common electronic documents that are within the first document set and the second document set;
determining one or more semantically similar terms of electronic documents within the overlap region;
generating one or more additional search queries based on the one or more semantically similar terms;
searching the electronic document database using the one or more additional search queries to obtain one or more additional document sets; and
displaying one or more visual representations of one or more search result sets using the one or more additional search queries.

15. The method as claimed in claim 14, wherein the one or more visual representations indicate a number of electronic documents within the one or more search result sets.

16. The method as claimed in claim 14, wherein user selection of the one or more visual representations generates a preview of electronic documents within the selected visual representation of electronic documents.

17. The method as claimed in claim 14, wherein one or more electronic documents within the one or more additional document sets are not contained in the first document set and the second document set.

18. The method as claimed in claim 14, wherein determining one or more semantically similar terms comprises identifying one or more common terms within electronic documents contained in the overlap region, generating semantic terms that are semantically similar to the one or more common terms, and identifying common semantic terms within the electronic documents contained in the overlap region.

19. The method as claimed in claim 14, further comprising, in response to a user input, generating a visualization chart of electronic documents within the first circle, the second circle, or the overlap region, wherein the visualization chart of electronic documents represents the electronic documents sorted by one or more structured data fields.

20. The method as claimed in claim 14, further comprising displaying text describing electronic documents within the first circle, the second circle, and the overlap region.
